(19) United States
(12) Patent Application Publication
(10) Pub. No.: US 2013/0219213 A1
(43) Pub. Date: Aug. 22, 2013

(54) SYSTEM AND METHOD FOR RECOVERING DATA OF HARD DISKS OF COMPUTING DEVICE

(71) Applicant: Hon Hai Precision Industry Co., Ltd., (US)

(72) Inventor: CHIH-HUANG WU, New Taipei (TW)

(73) Assignee: HON HAI PRECISION INDUSTRY CO., LTD., New Taipei (TW)

(21) Appl. No.: 13/756,413

(22) Filed: Jan. 31, 2013

(30) Foreign Application Priority Data
Feb. 21, 2012 (TW) 101105581

(51) Int. Cl. G06F 11/20

(52) U.S. Cl. CPC G06F 11/2094
USPC 714/6.22

(57) ABSTRACT

A computing device includes a redundant array of independent disks (RAID) card, a serial attached small computer system interface expander (SAS expander), and a RAID array. The RAID array includes a plurality of hard disks. Each hard disk of the RAID array connects with at least one backup hard disk. If a hard disk of the RAID array malfunctions, the computing device selects a backup hard disk. The computing device stores data which are stored in a hard disk of the RAID which is not malfunctioning into the selected backup hard disk.

### BACKGROUND

1. Technical Field

Embodiments of the present disclosure relate to hard disk management systems and methods, and particularly to a system and a method for recovering data of hard disks of a computing device.

2. Description of Related Art

A redundant array of independent disks (RAID) includes a plurality of hard disks. If a hard disk of the RAID array is malfunctioning, the hard disk needs be changed manually. When a technician is swapping out the malfunctioning disk, he/she must take extra precaution because data stored in the hard disk of the RAID array may be lost. This is an inconvenience.

### BRIEF DESCRIPTION OF THE DRAWINGS

FIG. 1 is a block diagram of one embodiment of a computing device including a recovery system.

FIG. 2 is a block diagram of one embodiment of function modules of the recovery system in FIG. 1.

FIG. 3 is a flowchart illustrating one embodiment of a method for recovering data of hard disks of the computing device.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

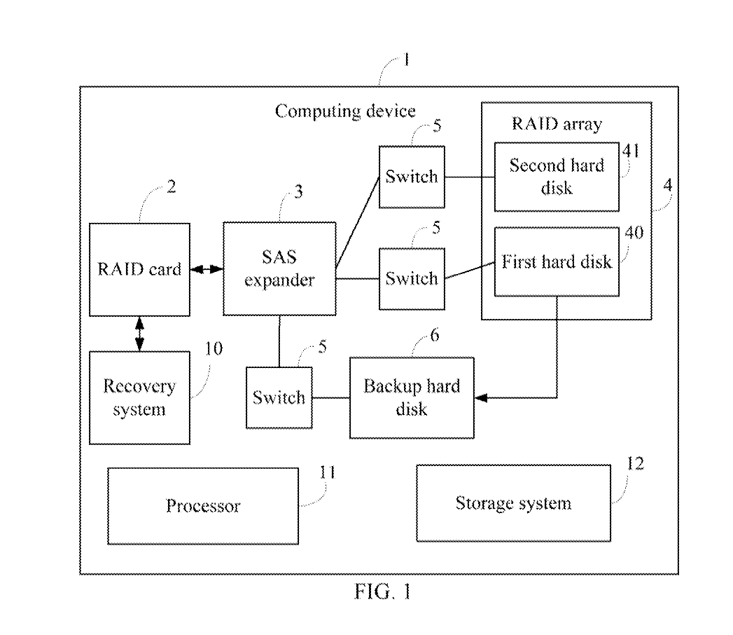

FIG. 1 is a block diagram of one embodiment of a computing device 1 including a recovery system 10. In one embodiment, the computing device 1 may be a computer, a server, for example. The computing device 1 includes a redundant array of independent disks (RAID) card 2, a serial attached small computer system interface expander (SAS expander) 3, and a RAID array 4. In one embodiment, the RAID array 4 is in a RAID 1 level. The RAID array 4 includes a first hard disk 40 and a second hard disk 41. The RAID card 2 communicates with the RAID array 4 via the SAS expander 3. The SAS expander 3 includes a plurality of ports. Each port connects with a hard disk of the RAID array 4 via a switch 5. In an initial state, each switch 5 connected with each hard disk of RAID array 4 is in a closed state. When a switch 5 is in the closed state, the SAS expander 3 can communicate with the hard disk of the RAID array 4 which connects with the switch 5. Each hard disk of the RAID array 4 connects with at least one backup hard disk 6 (only one shown in FIG. 1). Each backup hard disk 6 connects with the SAS expander 3 via a switch 5. In the initial state, the switch 5 which connects with each backup hard disk 6 is in an open state. When the switch 5 is in the open state, the SAS expander 4 cannot communicate with the backup hard disk 6.

When a hard disk of the RAID array 4 is malfunctioning, the recovery system 10 sets the switch 5, which connects with the malfunctioning hard disk of the RAID array 4, to the open state. Furthermore, the recovery system 10 selects a backup hard disk 6 connected with the malfunctioning hard disk of the RAID array 4, and sets the switch 5 which connects with the selected backup hard disk 6, to the closed state. For example, when the first hard disk 40 is malfunctioning, the SAS expander 3 cannot communicate with the first hard disk 40. The recovery system 10 sets the switch 5 connected to the first hard disk 40 to the open state, selects the backup hard disk 6 which connects with the first hard disk 40, and sets the switch 5 which connects with the selected backup hard disk 6 to the closed state, so that the SAS expander 3 can communicates with the selected backup hard disk 6. The selected backup hard disk 6 and the second hard disk 41 constitute a new RAID array 4.

In an embodiment, the computing device 1 includes at least one processor 11 and a storage system 12. In one embodiment, the storage system 12 may be a magnetic storage system, an optical storage system, or other suitable storage medium.

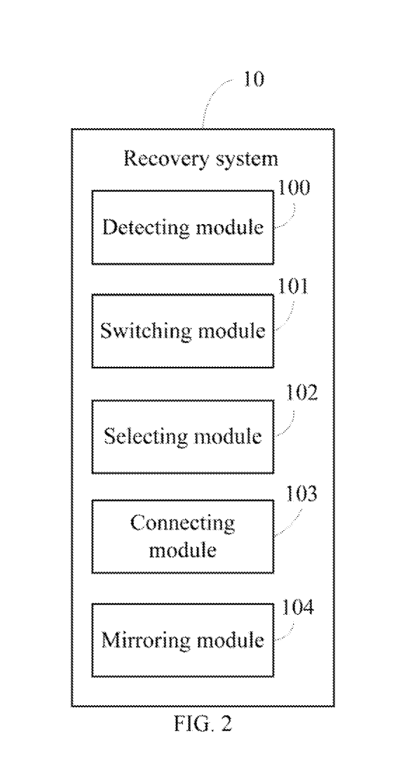

As shown in FIG. 2, the recovery system 10 includes a detecting module 100, a switching module 101, a selecting module 102, a connecting module 103, and a mirroring module 104. The one or more modules may comprise computerized instructions in the form of one or more programs that are stored in the storage system 12 and executed by the at least one processor 11 to provide functions of the modules 100-104.

The detecting module 100 controls the RAID card 2 to detect whether a hard disk of the RAID array 4 being malfunctioning. For example, the detecting module 100 sends first data to the RAID card 2. The RAID card 2 sends the first data to the first hard disk 40 and the second hard disk 41. Then, the detecting module 100 receives a second data from the first hard disk 40 and a third data from the second hard disk 41. If the second data and the third data are the same as the first data, the detecting module 100 determines that the first hard disk 40 and the second hard disk 41 are not malfunctioning. If the second data or the third data is different from the first data, the detecting module 100 determines that the first hard disk 40 or the second hard disk 41 is malfunctioning.

When a hard disk of the RAID array 4 which is malfunctioning (the first hard disk 40, for example), the switching module 101 cuts off the switch 5 which connects with the SAS expander 3 and the hard disk of the RAID array 4. The hard disk of the RAID array 4 cannot communicate with the SAS expander 3. For example, the switching module 101 cuts off the switch 5 connecting with the first hard disk 40. The first hard disk 40 cannot communicate with the SAS expander 3.

The selecting module 102 selects a backup hard disk 6 from at least one backup hard disk 6 which connects with malfunctioning the hard disk of the RAID array 4. In other embodiments, if more than one hard disks of the RAID array 4 are malfunctioning, the selecting module 102 selects more than one backup hard disk 6. A number of the selected backup hard disk 6 is the same as a number of the malfunctioning hard disk of the RAID array 4.

The connecting module 103 connects the SAS expander 3 to the selected backup hard disk 6 by setting the switch 5 connecting with the selected backup hard disk 6 in the closed state.

The mirroring module 104 stores the data stored in the hard disk of the RAID array 4 which is not malfunctioning into the selected backup hard disk 6. The selected backup hard disk 6 and the hard disk 41 which is not malfunctioning constitute a new RAID array 4. For example, the second hard disk 41 is not malfunctioning. The selected backup hard disk 6 which connects to the first hard disk 40 and the second hard disk 41 constitute the new RAID array 4. The SAS expander 3 communicates with the new RAID array 4.

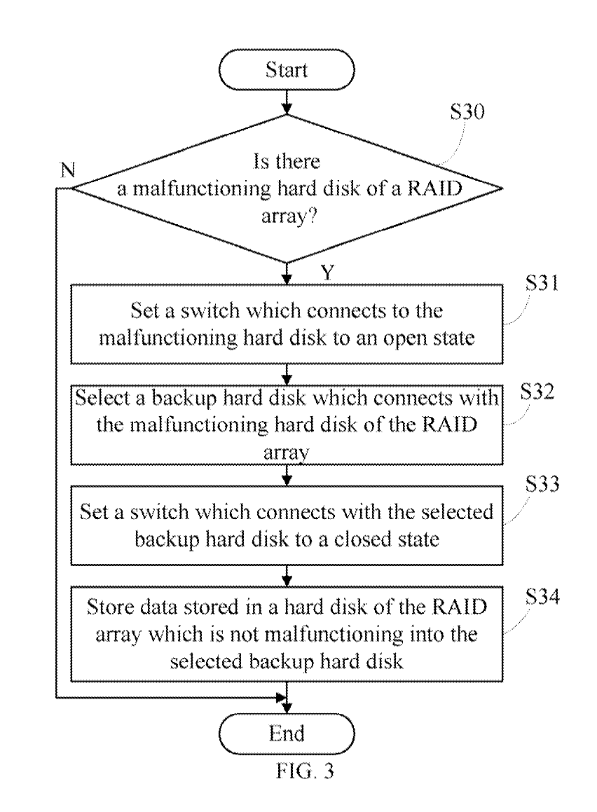

FIG. 3 is a flowchart illustrating a method for recovering data of hard disk of the computing device 1 in FIG. 1. Depending on the embodiment, additional steps may be added, others removed, and the ordering of the steps may be changed.

In step S30, the detecting module 100 controls the RAID card 2 to detect whether a hard disk of the RAID array 4 is malfunctioning. If a hard disk of the RAID array 4 being malfunctioning, step S31 is implemented. If no hard disk of the RAID array 4 is malfunctioning, the procedure ends.

In step S31, the switching module 101 sets the switch 5 which connects to the detected hard disk, which is malfunctioning, to an open state, so as to cut off the connection between the SAS expander 3 and the detected hard disk.

In step S32, the selecting module 102 selects a backup hard disk 6 which connects with the detected hard disk of the RAID array 4.

In step S33, the connecting module 103 sets the switch 5 which connects with the selected backup hard disk 6 to a closed state, so as to establish the connection between the SAS expander 3 and the selected backup hard disk 6.

In step S34, the mirroring module 104 stores the data stored in the hard disk of the RAID array 4 which is not malfunctioning into the selected backup hard disk 6.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a serial attached small computer system interface (SAS) expander;
a redundant array of independent disks (RAID);
a storage system;
at least one processor; and
one or more programs stored in the storage system and executed by the at least one processor, the one or more programs comprising:
a switching module that cuts off a switch which connects with the SAS expander and a malfunctioning hard disk of the RAID array;
a selecting module that selects a backup hard disk which connects with the malfunctioning hard disk of the RAID array;
a connecting module that connects the SAS expander to the selected backup hard disk; and
a mirroring module that stores data which are stored in a hard disk of the RAID array which is not malfunctioning into the selected backup hard disk.

2. The computing device as described in claim 1, wherein the computing device further comprises a RAID card which communicates with the RAID array via the SAS expander.

3. The computing device as described in claim 2, wherein the RAID card communicates with the RAID array via switches which connect with the hard disk of the RAID array.

4. The computing device as described in claim 1, wherein the switch which connects with the SAS expander and the malfunctioning hard disk of the RAID array is cut off by setting the switch to an opened state.

5. The computing device as described in claim 1, wherein the SAS expander and the selected backup hard disk is connected by setting a switch connected with the SAS expander and the selected backup hard disk to a closed state.

6. A method being executed by a processor of a computing device for recovering data of hard disks of a computing device, comprising:
cutting off a switch which connects with a serial attached small computer system interface (SAS) expander of the computing device and a malfunctioning hard disk of a redundant array of independent disks (RAID) array;
selecting a backup hard disk which connects with the malfunctioning hard disk of the RAID array;
connecting the SAS expander to the selected backup hard disk; and
storing data which are stored in a hard disk of the RAID array which is not malfunctioning into the selected backup hard disk.

7. The method as described in claim 6, wherein the RAID array communicates with a RAID card of the computing device via the SAS expander.

8. The method as described in claim 6, wherein the cutting step comprises: setting the switch which connects with the SAS expander and the malfunctioning hard disk of the RAID array to an opened state.

9. The method as described in claim 6, wherein the connecting step comprises: setting a switch connected with the SAS expander and the selected backup hard disk to a closed state.

10. A non-transitory storage medium having stored thereon instructions that, when executed by a processor, causes the processor to perform a method for recovering data of hard disk of a computing device, the method comprising:
cutting off a switch which connects with a serial attached small computer system interface (SAS) expander of the computing device and a malfunctioning hard disk of a redundant array of independent disks (RAID) array;
selecting a backup hard disk which connects with the malfunctioning hard disk of the RAID array;
connecting the SAS expander to the selected backup hard disk; and
storing data which are stored in a hard disk of the RAID array which is not malfunctioning into the selected backup hard disk.

11. The non-transitory storage medium as described in claim 10, wherein the RAID array communicates with a RAID card of the computing device via the SAS expander.

12. The non-transitory storage medium as described in claim 10, wherein the cutting step comprises: setting the switch which connects with the SAS expander and the malfunctioning hard disk of the RAID array to an opened state.

13. The non-transitory storage medium as described in claim 10, wherein the connecting step comprises: setting a switch connected with the SAS expander and the selected backup hard disk to a closed state.
